(19) United States
(12) Patent Application Publication
(10) Pub. No.: US 2020/0117737 A1
(43) Pub. Date: Apr. 16, 2020

(54) FAST HETEROGENEOUS MULTI-DATA SOURCE SEARCH AND ANALYTICS

(71) Applicant: LeapAnalysis Inc., Melbourne, FL (US)

(72) Inventors: Deepak Gopalakrishnan, Kerala (IN); Eric Little, Indialantic, FL (US); Tortsen Osthus, Roetgen (DE)

(21) Appl. No.: 16/162,309

(22) Filed: Oct. 16, 2018

(51) Int. Cl. G06F 17/30

(52) U.S. Cl. CPC G06F 17/30477; G06F 17/30557; G06F 17/30958; G06F 17/30389; G06F 17/30533; G06F 17/30991

(57) ABSTRACT

Embodiments of the present invention provide for a method, system and computer program product for fast heterogeneous multi-data source search and analytics. In an embodiment of the invention, a method includes receiving a specification of multiple different data sources in a search and analytics engine, establishing communicative links between the engine and the data sources, and identifying a data source type and corresponding data fields storing respective data for each data source. The method further includes specifying a multi-hop graph traversal query implicating data across the different data sources, decomposing the query into constituent components and mapping each of the constituent components to each of the data sources based upon the corresponding data fields. The method even further includes formulating a specific query for each of the data sources, transmitting each query to each data source and populating in a knowledge graph each result set received for each query.

### BACKGROUND OF THE INVENTION

### Field of the Invention

The present invention relates to the field of data management and more particularly to data management of multiple heterogeneous data sources.

### Description of the Related Art

A database is an organized collection of data and a database management system (DBMS) is often used to create, update, delete, query and generally administer the database. In order to properly query a database or data source, the data in the database is organized and indexed according to the preferred convention. Currently, there are many forms of database models that indicate how data is organized in the database, such as spreadsheets, relational databases based on Structured Query Language (SQL), NoSQL databases, Not Only SQL databases, object databases, etc. Within those database models, the schema used to organize data will differ between database models and schemas such as RDF, object, tabular, tuple, triplestores, graph, etc. may be used. Alternatively, data files may not be stored with any specific organization measures and may simply include JSON files, XML files, text files, spreadsheets or multimedia such as images, video, audio, etc. without an organization schema.

Tabular databases (relational, NoSQL, etc.) use indexes and logic tables to show the relational structure between elements in the database. Such databases are useful for quickly finding results but limited by the schema with which the database was built. A graph database is a specific type of database that is modeled based on graph theory where data is represented in a non-tabular fashion. Data is stored as nodes, defining the entities, and edges, defining the relationships between those entities. Thus, elements of a graph database are interconnected to depict how those elements are related to other elements in the database. A graph database is useful for determining complex relationships between elements and can be useful for easily developing new schemas; however, graph databases are significantly more complex than relational databases.

The ways in which an end user queries a database is dependent on the type of database being queried. Databases, or more specifically relational databases, most often use SQL in order to query data that are stored in tables. On the other hand, there is currently no universally accepted query language to query graph databases, although the Resource Description Framework (RDF) is commonly used in many cases. With advances in natural language processing (NLP), more simplified approaches to querying are being utilized to allow for less-structured searches involving text documents. Also, it is noted that a query may be different based on whether the end user wishes to query the metadata of the data or the instances of the data.

With the amount of different types of databases and associated data, due to legacy databases or based on the type of data required, multiple heterogenous databases often exist within large federated and disparate IT systems, spread across organizations. Additionally, with the advent of big data applications, oftentimes separate queries will have to be conducted for different data types for a single application. Not only are separate queries required, oftentimes the nodes or indices of a pre-built database require additional nodes or indices based on new knowledge in order to be of value to the query. Thus, end users must either spend a significant amount of time running multiple queries over multiple data types or spend a significant amount of time organizing and indexing data into a new, single schema, which is hard to predict in advance. Thus, the storage and analysis of data files based on specific organization of databases place significant limitations on big data applications, such as machine learning, as the data with different organizational measures cannot be easily compared.

### BRIEF SUMMARY OF THE INVENTION

Embodiments of the present invention address deficiencies of the art in respect to database management of multiple heterogeneous databases and provide a novel and non-obvious method, system and computer program product for fast heterogeneous multi-data source search and analytics. In an embodiment of the invention, a method for fast heterogeneous multi-data source search and analytics is claimed. The method includes receiving a specification of multiple different data sources in a user interface to a search and analytics engine, establishing communicative links between the engine and each specified one of the data sources and identifying for a corresponding one of the data sources through a respective one of the communicative links, a data source type and corresponding data fields storing respective data. The method further includes specifying in the user interface, a multi-hop graph traversal query implicating data across the multiple different data sources, decomposing the query into constituent components and mapping each of the constituent components to a corresponding one of the data sources based upon the identified corresponding data fields of each of the data sources. The method even further includes formulating a specific query for each of the corresponding one of the data sources mapped to one of the constituent components, transmitting each formulated specific query to a corresponding one of the data sources, receiving in response a result set and populating in a single knowledge graph each result set received for each specific query transmitted to a corresponding one of the data sources.

In one aspect of the embodiment, the method further includes storing relationship data between the different data sources and wherein the mapping is based on the stored relationship data. In another aspect of the embodiment, the method further includes storing translation data between the multi-hop graph traversal query and the data source types of the different data sources and wherein the translation data is used to formulate the specific queries. In yet another aspect of the embodiment, the method further includes storing query relationship data between previous queries and corresponding previous result sets and wherein the mapping is based on learned rules determined from the stored relationship data. In even yet another aspect of the embodiment, the method further includes determining a pattern of usage of a user profile and selecting only the corresponding data sources based on the pattern of usage of the user profile performing the query, or across a pattern of usage from similar users. In a final aspect of the embodiment, the method further includes monitoring changes to data in each specified one of the data sources, determining rules based on the monitored changes in the data in the different data sources and wherein the mapping is based on the rules between the different data sources.

In another embodiment of the invention, a data processing system configured for fast heterogeneous multi-data source search and analytics has been claimed. The system includes a host computing platform comprising one or more computers, each with memory and at least one processor, multiple different data sources communicating with the host computing platform over a network, and a search and analytics engine executing in the memory of the host computing platform. The engine includes program code enabled upon execution in the host computing platform to receive in a user interface to a search and analytics engine, a specification of the multiple different data sources, to establish communicative links, each between the engine and each specified one of the data sources, and to identify for a corresponding one of the data sources through a respective one of the communicative links, a data source type and corresponding data fields storing respective data. The program code is further enabled to specify in the user interface, a multi-hop graph traversal query implicating data across the multiple different data sources, to decompose the query into constituent components and map each of the constituent components to a corresponding one of the data sources based upon the identified corresponding data fields of each of the data sources. The program code is even further enabled to formulate a specific query for each of the corresponding one of the data sources mapped to one of the constituent components, to transmit each formulated specific query to a corresponding one of the data sources, receive in response a result set and to populate in a single knowledge graph each result set received for each specific query transmitted to a corresponding one of the data sources.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for fast heterogeneous multi-data source search and analytics;

FIG. 2 is a schematic illustration of a data processing system configured for fast heterogeneous multi-data source search and analytics; and

FIG. 3 is a flow chart illustrating a process for fast heterogeneous multi-data source search and analytics.

### DETAILED DESCRIPTION OF THE INVENTION

Embodiments of the invention provide for fast heterogeneous multi-data source search and analytics. In accordance with an embodiment of the invention, a search and analytics engine may be connected over a network to multiple heterogeneous data sources. The data sources may be completely federated. An end user may then query data stored within the multiple different heterogenous data sources through a multi-hop graph traversal query. To that end, when the end user provides the query to the analytics engine, the analytics engine automatically determines the data sources to query based on stored metadata tags and metadata relationships between the data sources as defined as nodes and edges of a single knowledge graph. The analytics engine then formulates a specific query for each of the data sources relevant to the original query and translates the query based on the specific schema or custom schema of each of the data sources. The analytics engine then populates each of the results in a single result set and feeds the results back into the knowledge graph. In this way, a single knowledge graph populated by metadata that corresponds to data contained in multiple heterogeneous federated, graphical and/or non-graphical, data sources and the relationships between the data is utilized to generate query results from the heterogeneous data sources while the actual data remains at the sources. This is accomplished without needing an overarching master data model, as is often seen in Data Warehouse indexing, or a master index as is often seen in data lakes.

Optionally, in addition to the predefined translations between schemas, the analytics engine may translate the query based upon learned translation schema between different data schemas. Also, in addition to the predefined relationships between data sources and respective schema and namespaces, the analytics engine may store logically or statistically learned relationships and suggest probable relationships between different data sets in the heterogenous databases in order to provide better result sets to a query, recommended result sets to the query and optimize the traversal strategies of the analytics engine. The translation and relationship data may be metadata relationships about the joins across both graph, tabular & image-based data sources stored across the data sources. Machine learning and logical reasoning may be used in combination to develop the translation capabilities between the different schema and recommend relationships between heterogenous data sets. As well, the analytics engine may store predefined and learned relationships of data and data sources that each user or group of users are most probable to access based on their respective roles identified upon sign in, or their queries in order to optimize the recommendation and traversal strategies of the analytics engine. Thus, when a user is operating the engine their associated user traversal strategy is loaded in order to optimize their search. Similarly, the relationships between a user or a group of users and data may be utilized to recommend related result sets from similar users or groups of users. Thus, the corresponding data sources may be selected across a pattern of usage from similar users (a community of interest of sorts) where recommendations can be made from these learnings.

As a further option, the analytics engine may monitor changes to the data stored in the multiple heterogeneous data sources in order to develop fuzzy inference rules between changes in related data. In particular, the fuzzy inference rules probabilistically determine relationships between data points and can similarly be stored in cognitive data structures, so that when a user changes one portion of data, the related portion of data can automatically change or the user can be notified of the related data to change. All of these rules may be predefined rules, dynamic, learned rules or a combination thereof, in order to optimize the search results.

In even yet a further option, the metadata repository that stores the metadata that corresponds to data stored in the heterogenous databases and organized by the knowledge graph may be automatically merged and sorted to optimize search results. When the metadata is read from the respective data sources, the analytics engine may utilize the respective sort implementation of the connected data source and then perform either an on or off the disk merge within the metadata repository. As well, the results to a query may be automatically merged and sorted to optimize the search results with the respective relationships between the data sources. Furthermore, the end user may define scripts or domain-specific languages to automatically schedule and run queries within the analytics engine.

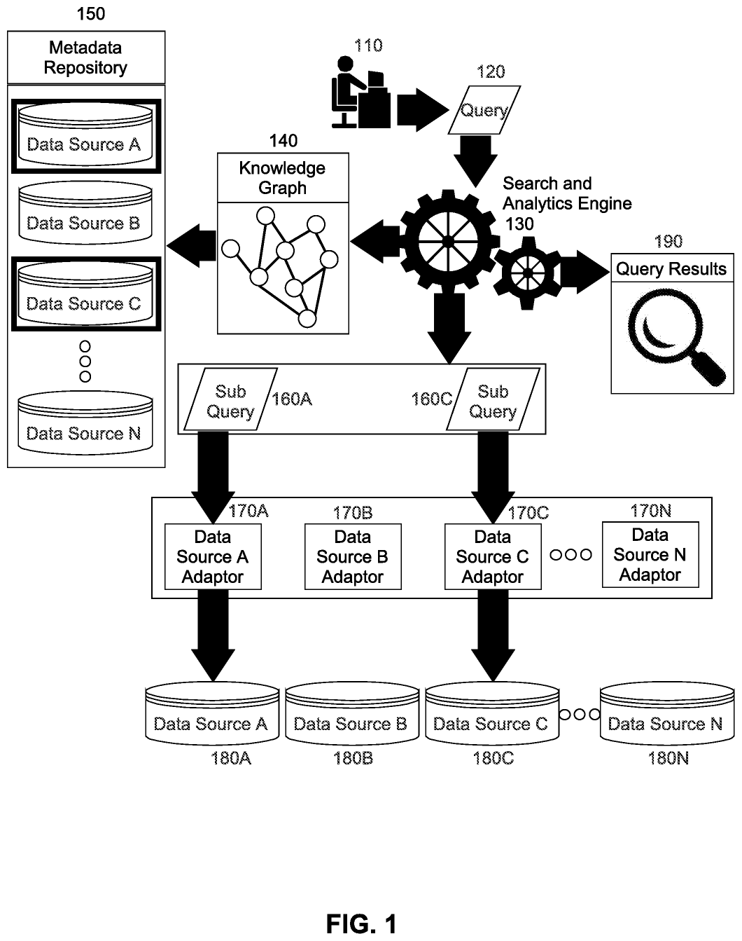

In further illustration, FIG. 1 pictorially shows a process for fast heterogeneous multi-data source search and analytics. As shown in FIG. 1, search and analytics engine 130 communicates with multiple heterogenous data sources 180A, 180B, 180C, 180N. The communicative links may be virtualized. Search and analytics engine 130 receives a specification of each of the multiple heterogenous data sources 180A, 180B, 180C, 180N. Data sources 180A, 180B, 180C, 180N may be completely federated. Search and analytics engine 130 is able to identify the data source types, schema, namespaces, etc. for the corresponding data fields of each of the data sources 180A, 180B, 180C, 180N. Search and analytics engine 130 is driven by knowledge graph 140 that defines the nodes and edges of the metadata stored in metadata repository 150 that corresponds to the data stored in each of the data sources 180A, 180B, 180C, 180N. Thus, the relationships between the data sources are defined in knowledge graph 140 and stored in the metadata repository 150. In order to maintain the federated nature of the data, search and analytics engine 130 may read data sources 180A, 180B, 180C, 180N and read/write the data in the knowledge graph 140 and metadata repository 150.

End user 110 can input or automatically schedule a query 120 into the search and analytics engine 130. The query 120 may be a multi-hop graph traversal query in order to apply a graph query to graph and non-graph data sources. Furthermore, an end user may input a different query type, such as a graph query, a relational query, natural language query, etc., and the search and analytics engine 130 may translate the query to the required query type using the respective translation or natural language processing technique. Thus, a user can input their desired query format and the search and analytics engine 130 will still be able to perform the multi-hop graph traversal query against graph and non-graph data sources.

Subsequent to the translation of the end user's query 120 to a multi-hop graph traversal query, the query is decomposed to its constituent components of the original query and mapped to each of the respective data types of the data fields in the each of the relevant data sources 180A, 180B, 180C, 180N. As can be seen, in the example shown in FIG. 1, query 120 is decomposed and mapped to data source A 180A and data source C 180C resulting in sub-queries 160A and 160C. In doing so, data source B 180B, as well as the rest of the data sources 180N are traversed resulting in a more efficient query process. The mapping of the decomposed query to the respective data sources is based on the predefined and learned relationships between the data sources, as contained in the metadata repository 150 and defined by the knowledge graph 140.

The mapping of the query to the respective data sources may be based on predefined and learned query-data source relationship and traversal rules, as well as predefined and learned user-data source relationship and traversal rules. The query-data source rules may be based on the relationships between the data sources 180A, 180B, 180C, 180N as stored in the knowledge graph 140 and metadata repository 150. Additionally, the query-data source rules may be learned rules from previous queries and resulting data sets. Furthermore, the query-data source rules may be based on fuzzy logic rules that develop a correlation between monitored changes in related data sets. The user-data source rules may be predefined rules based on a user profile of the end user 110, or a profile for a group of users, and may include information such as job type and available data sources. The user-data source rules may also be based on learned patterns of the user or group of users. Thus, in using query-data source relationship and traversal rules and user-data source relationship and traversal rules, the search and analytics engine may provide collaborative filtering of data sources to be searched, recommendations of related data, as well as general traversal strategies of specific data sources.

As can be seen, based on the relationships between the user 110 inputting the query, the query 120, the data sources 180A, 180B, 180C, 180N as contained in the metadata repository 150 and defined by the knowledge graph 140, the constituent components are mapped to each respective data types of the data fields in data sources 180A and 180C resulting in sub-queries 160A and 160C. Search and analytics engine 130 may automatically translate the queries for the respective data type, schema, namespace, etc. of the data sources 180A and 180C or sub-queries 160A and 160C may be fed through a data source adaptor 170A and 170C to translate the query. The translation of the sub-queries 160A and 160C may be based on predefined and learned translation rules. The translation rules may be based on predefined translations between data type, schema, namespace, etc., which logically specifies the translation between different data structures in the heterogenous data sources. As such, data source adaptor 170A, 170B, 170C, 170N may be defined for custom data storage. The translation rules may also be based on learned translation rules from previous query result sets as determined from the knowledge graph 140 and metadata repository 150. Thus, the formulation of specific queries by translating the queries allows for queries of single or multiple different namespaces. Furthermore, if the data type includes multimedia, such as audio, video, or images, computer vision and natural language processing may be utilized to search or query any data type.

Furthermore, data source adaptors 170A, 170B, 170C, 170N allow the sub-queries to be performed independently, as well as the subsequent responses to the sub-queries, translation back into the desired schema and display to the end user. This allows the search and analytics engine 130 to receive, translate and display results from different underlying data processing architectures of the heterogeneous data sources. For example, data source A 180A may allow for processing under Lambda architecture and data source C 180C may allow for processing under Kappa architecture. In that case, data source adaptor 170A may act as a read adaptor for the batch layer and may also in turn display the results from the speed layer in result set 190 through a serving layer as the data is still processing. As the search and analytics engine 130 allows for multiple serving layers, the batch layer does not need to be a single data store and it is possible to have different levels of random access speeds and parallel processing of data.

Following the transmission of the translated sub-queries 160A and 160C to each respective data source 180A and 180C, a result set is received for each sub-query and the result sets are populated in a single query result 190. The query result 190, along with the results sets from previous and subsequent queries, are input into the knowledge graph 140 and stored in metadata repository 150 and used to drive the search index. Thus, the results of the specific query are stored in a single ontology of the knowledge graph 140, so that the results can be further processed under the single ontology. The knowledge graph defining the nodes and edges of the metadata repository 150 allows for an efficient way to utilize the computational graph architecture to apply machine learning to the data contained in the federated data sources 180A, 180B, 180C, 180N. The result set 190 may include data of data sources 180A, 180B, 180C, 180N, metadata of the data, persisted instance information, or any result of the query 120, sub-queries 160A and 160C or real time view thereof. The result sets are translated, based on similar translation rules as mentioned above, into a desired result set schema for the end user. The desired schema may be in tabular form or graph form. The query results 190 of the query 120 that include the results of the different sub-queries 160A and 160C are displayed to the end user. Finally, all of the above-mentioned results are fed back into the search and analytics engine 130 in order to optimize the search and analytics engine 130.

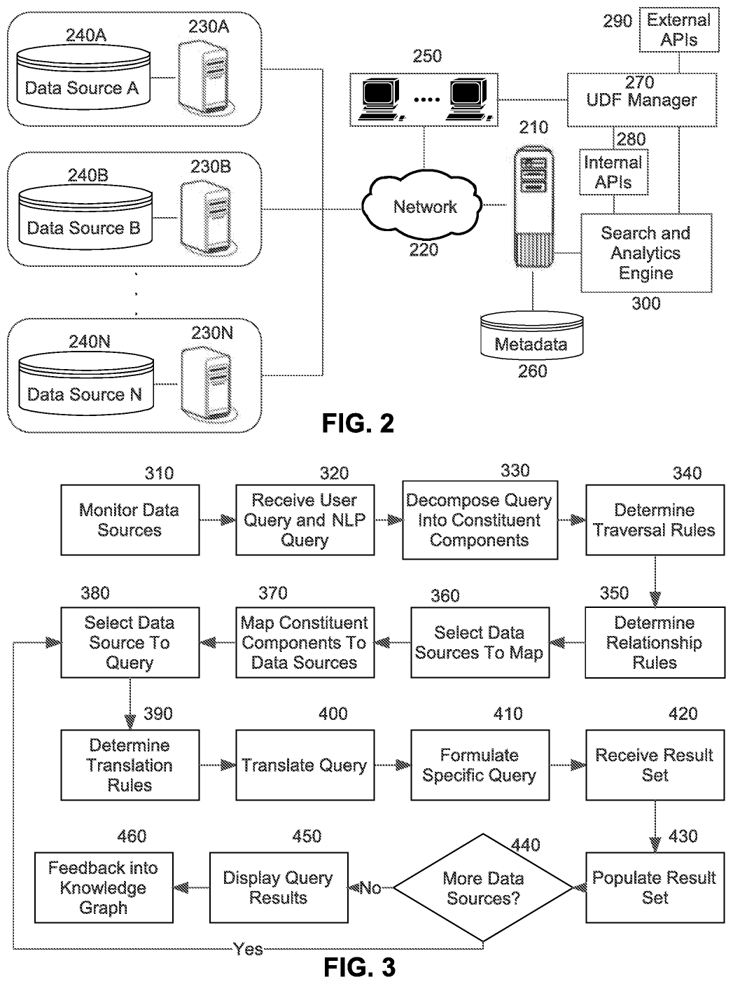

The process described in connection with FIG. 1 can be implemented in a data processing system. In yet further illustration, FIG. 2 schematically shows a data processing system configured for fast heterogeneous multi-data source search and analytics. The system can include a computing system 210 of one or more servers each with memory and at least one processor, collectively configured to support the execution of a data processing system that communicates with, and may monitor, multiple heterogenous data sources 240A, 240B, 240N. The heterogenous data sources 240A, 240B, 240N may be federated and have their own respective servers 230A, 230B, 230N or may be directly connected to the host computing system 210. The data sources 240A, 240B, 240N may also reside in network servers that communicate with the host computing system 210 over the internet. The host server computing system 210 can be configured for communicatively coupling to different client computers 250 over computer communications network 220 such that requests to access the data processing system can be received in the host computing system 210 from applications executing in respective ones of the client computers 210.

Importantly, a search and analytics engine 300 can be coupled to the data processing system 210. The search and analytics engine 300 communicates with data sources 240A, 240B, 240N through the host computing system 210.The search and analytics engine 300 may also monitor data changes in the data sources 240A, 240B, 240N through the host computing system 210. The search and analytics engine 300 maintains a specification of the data sources 240A, 240B, 240N and also maintains relationship data between the data sources. The relationship data may be predefined rules or learned rules between the data in the respective data sources 240A, 240B, 240N, queries and end users, as stored in a knowledge graph of metadata repository 260.

The search and analytics engine 300 receives a query from an end user input through a user interface of a client computer 250. The search and analytics engine 300 translates the query then decomposes the query into its constituent components and maps the constituent components to each of the types of data in the respective data sources 240A, 240B, 240N based on the relationships stored in metadata repository 260. The search and analytics engine 300 may then formulate a specific query for each data type of the data sources 240A, 240B, 240N, transmit each specific query to each data source, and receive a result set from each data source in response to the specific query. The search and analytics engine 300 populates each of the results in a single result set for the end user and may display the search results to the end user in a user interface of the client computer 250. The results of the query are stored in the knowledge graph in metadata repository 260 in order to optimize the search and analytics engine 300.

Search and analytics engine 300 may also be connected to a user-defined function (“UDF”) manager 270. The query from an end user may be input through a user interface of a client computer 250 to the search and analytics engine 300 directly, through the UDF manager 270, or may be automatically scheduled through the UDF manager 270. The query input through the UDF manager 270 may be in communication with the search and analytics engine 300 directly or one or more internal Application Programming Interfaces (“APIs”) or scripts or plugins 280 to input the query through the search and analytics engine 300. The internal APIs or scripts or plugins 280 may be in communication with the search and analytics engine 300 directly or the metadata repository 260 directly in order to optimize the query and/or results and select the data sources to be queried based on the desired specifications of the query. The UDF manager 270 may also be extended with external APIs or scripts or plugins 290 in order to allow the end user optimize their query and/or results using external APIs or scripts or plugins. The external APIs or scripts or plugins 290 may be in communication with search and analytics engine 300 or the metadata repository 260 directly in order to optimize the query and select the data sources to be queried directly. Thus, internal and external APIs or scripts or plugins 280 and 290 through the UDF manager 270 may be utilized so that an end user can optimize and design queries to their desired specifications.

In yet further illustration of the process performed by the program code of the search and analytics engine 300, FIG. 3 is a flow chart illustration a process for fast heterogeneous multi-data source search and analytics. Beginning in block 310, the search and analytics engine monitors the data sources for changes and maintains a specification of each of the data sources defining the schema, data types, namespaces and metadata of the data in each of the data sources. In block 320, a user query is received, translated into a multi-hop graph traversal query and, in block 330, the query is decomposed into its constituent components. In block 340, the predefined and learned traversal rules for the query, data sources and user performing the query are determined. In block 350, the predefined and learned relationships between query, data sources, and user performing the query are determined. Applying the rules of blocks 340 and 350, in block 360, data sources are selected to be queried. In block 370, the constituent components of the original query are mapped to the selected data sources.

In block 380, the first data source is selected to query and, in block 390, the predefined and learned translation rules for the data type of that data source are determined. In block 400, the query is translated for the data of the data source and, in block 410, a specific query is formulated for that data source. In response to that specific query, in block 420, a result set from that data source is received, translated and populated into a single result set in block 430. In block 440, if there are more data sources, the process repeats from block 380 until there are no more data sources to query. After specific queries for all of the data source are completed, in block 450, the search results may be displayed for the end user. The user may also be provided a real time view of the search results while the queries are processing at different random access speeds. Finally, in block 460, the results from the query are stored in a metadata repository as a single knowledge graph in order to optimize the search and analytics engine.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for fast heterogeneous multi-data source search and analytics comprising:
receiving in a user interface to a search and analytics engine, a specification of multiple different data sources;
establishing communicative links, each between the engine and each specified one of the data sources;
identifying for a corresponding one of the data sources through a respective one of the communicative links, a data source type and corresponding data fields storing respective data;
specifying in the user interface, a multi-hop graph traversal query implicating data across the multiple different data sources;
decomposing the query into constituent components and mapping each of the constituent components to a corresponding one of the data sources based upon the identified corresponding data fields of each of the data sources;
formulating a specific query for each of the corresponding one of the data sources mapped to one of the constituent components;
transmitting each formulated specific query to a corresponding one of the data sources and receiving in response a result set; and,
populating in a single knowledge graph each result set received for each specific query transmitted to a corresponding one of the data sources.

2. The method of claim 1, further comprising:
storing relationship data between the different data sources and wherein the mapping is based on the stored relationship data.

3. The method of claim 1, further comprising:
storing translation data between the multi-hop graph traversal query and the data source types of the different data sources and wherein the translation data is used to formulate the specific queries.

4. The method of claim 1, further comprising:
storing query relationship data between previous queries and corresponding previous result sets and wherein the mapping is based on learned rules determined from the stored relationship data.

5. The method of claim 1, further comprising:
determining a pattern of usage of a user profile and selecting only the corresponding data sources based on the pattern of usage of the user profile performing the query.

6. The method of claim 1, further comprising:
monitoring changes to data in each specified one of the data sources, determining rules based on the monitored changes in the data in the different data sources and wherein the mapping is based on the rules between the different data sources.

7. A data processing system configured for fast heterogeneous multi-data source search and analytics comprising:
a host computing platform comprising one or more computers, each with memory and at least one processor;
multiple different data sources communicating with the host computing platform over a network;
and a search and analytics engine executing in the memory of the host computing platform, the engine comprising program code enabled upon execution in the host computing platform to receive in a user interface to a search and analytics engine, a specification of the multiple different data sources, to establish communicative links, each between the engine and each specified one of the data sources, to identify for a corresponding one of the data sources through a respective one of the communicative links, a data source type and corresponding data fields storing respective data, to specify in the user interface, a multi-hop graph traversal query implicating data across the multiple different data sources, to decompose the query into constituent components and map each of the constituent components to a corresponding one of the data sources based upon the identified corresponding data fields of each of the data sources, to formulate a specific query for each of the corresponding one of the data sources mapped to one of the constituent components, to transmit each formulated specific query to a corresponding one of the data sources and receive in response a result set and to populate in a single knowledge graph each result set received for each specific query transmitted to a corresponding one of the data sources.

8. The system of claim 7, wherein the program code is further enabled to store relationship data between the different data sources and wherein the mapping is based on the stored relationship data.

9. The system of claim 7, wherein the program code is further enabled to store translation data between the multi-hop graph traversal query and the data source types of the different data sources and wherein the translation data is used to formulate the specific queries.

10. The system of claim 7, wherein the program code is further enabled to store query relationship data between previous queries and corresponding previous result sets and wherein the mapping is based on learned rules determined from the stored relationship data.

11. The system of claim 7, wherein the program code is further enabled to determine a pattern of usage of a user profile and select only the corresponding data sources based on the pattern of usage of the user profile performing the query.

12. The system of claim 7, wherein the program code is further enabled to monitor changes to data in each specified one of the data sources, determine rules based on the monitored changes in the data in the different data sources and wherein the mapping is based on the rules between the different data sources.

13. A computer program product for fast heterogeneous multi-data source search and analytics, the computer program product comprising a computer readable storage medium having program instructions embodied therewith, the program instructions executable by a device to cause the device to perform a method comprising:
receiving in a user interface to a search and analytics engine, a specification of multiple different data sources;
establishing communicative links, each between the engine and each specified one of the data sources;
identifying for a corresponding one of the data sources through a respective one of the communicative links, a data source type and corresponding data fields storing respective data;
specifying in the user interface, a multi-hop graph traversal query implicating data across the multiple different data sources;
decomposing the query into constituent components and mapping each of the constituent components to a corresponding one of the data sources based upon the identified corresponding data fields of each of the data sources;
formulating a specific query for each of the corresponding one of the data sources mapped to one of the constituent components;
transmitting each formulated specific query to a corresponding one of the data sources and receiving in response a result set; and,
populating in a single knowledge graph each result set received for each specific query transmitted to a corresponding one of the data sources.

14. The computer program product of claim 13, wherein the method further comprises:
storing relationship data between the different data sources and wherein the mapping is based on the stored relationship data.

15. The computer program product of claim 13, wherein the method further comprises:
storing translation data between the multi-hop graph traversal query and the data source types of the different data sources and wherein the translation data is used to formulate the specific queries.

16. The computer program product of claim 13, wherein the method further comprises:
storing query relationship data between previous queries and corresponding previous result sets and wherein the mapping is based on learned rules determined from the stored relationship data.

17. The computer program product of claim 13, wherein the method further comprises:
determining a pattern of usage of a user profile and selecting only the corresponding data sources based on the pattern of usage of the user profile performing the query.

18. The computer program product of claim 13, wherein the method further comprises:
monitoring changes to data in each specified one of the data sources, determining rules based on the monitored changes in the data in the different data sources and wherein the mapping is based on the rules between the different data sources.
